(19) United States
(12) Patent Application Publication
(10) Pub. No.: US 2005/0142664 A1
(43) Pub. Date: Jun. 30, 2005

(54) System, method, and product for mixing fluids in a chamber

(75) Inventor: Gregory C. Loney, Palo Alto, CA (US)

Correspondence Address: AFFYMETRIX, INC;ATTN: CHIEF IP COUNSEL, LEGAL DEPT., 3380 CENTRAL EXPRESSWAY, SANTA CLARA, CA, 95051, US

(73) Assignee: Affymetrix, INC., Santa Clara, CA (US)

(21) Appl. No.: 11/017,095

(22) Filed: Dec. 20, 2004

Related U.S. Application Data
(60) Provisional application No. 60/531,435, filed on Dec. 18, 2003.

(51) Int. Cl. G01N 1/00

(52) U.S. Cl. 436/174

(57) ABSTRACT

In one embodiment a method of mixing fluid is described that comprises providing a vibration comprising a resonant frequency; sympathetically amplifying the vibration in response to the resonant frequency; and modulating the resonant frequency, to cause the amplified vibration to generate turbulent flow in a fluid that influences the likelihood of interaction between a target molecule in the fluid with a probe on a biological probe array.

### RELATED APPLICATIONS

The present application is related to and claims priority from U.S. Provisional Patent Application Ser. No. 60/531,435, titled “System and Method for Improved Hybridization Using Embedded Resonant Mixing Elements”, filed Dec. 18, 2003, which is hereby incorporated by reference herein in its entirety for all purposes.

### BACKGROUND

1. Field of the Invention

The present invention relates to systems and methods for improving the efficiency of fluid mixing in a chamber that may also improve the rate and efficiency of hybridization of target molecules to probes disposed upon a probe array. In particular, the invention relates to embedded resonant elements that provides for a disruption of boundary layers and improves contact between target molecules and their associated probes. Additionally, the present invention provides for a lost cost means for mixing fluids.

2. Related Art

Synthesized nucleic acid probe arrays, such as Affymetrix GeneChip® probe arrays, and spotted probe arrays, have been used to generate unprecedented amounts of information about biological systems. For example, the GeneChip® Human Genome U133 Set (HG-U133A and HG-U133B) available from Affymetrix, Inc. of Santa Clara, Calif., is comprised of two microarrays (also called probe arrays) containing over 1,000,000 unique oligonucleotide features covering more than 39,000 transcript variants that represent more than 33,000 human genes. Analysis of expression data from such microarrays may lead to the development of new drugs and new diagnostic tools. In many experimental conditions, a proportion of target molecules may be present at very low levels where it is desirable to optimize the probability of the target molecules coming into contact with their associated probes when exposed to a probe array.

### SUMMARY OF THE INVENTION

Systems, methods, and products to address these and other needs are described herein with respect to illustrative, non-limiting, implementations. Various alternatives, modifications and equivalents are possible. For example, certain systems, methods, and products are described herein using exemplary implementations of experiments using arrays of biological materials such as Affymetrix® GeneChip® probe arrays. However, these systems, methods, and products may be applied with respect to many other types of probe arrays and, more generally, with respect to numerous parallel biological assays produced in accordance with other conventional technologies and/or produced in accordance with techniques that may be developed in the future. For example, the systems, methods, and products described herein may be applied to parallel assays of nucleic acids, PCR products generated from cDNA clones, proteins, antibodies, or many other biological materials. These materials may be disposed on slides (as typically used for spotted arrays), on substrates employed for GeneChip® arrays, or on beads, optical fibers, or other substrates or media. Moreover, the probes need not be immobilized in or on a substrate, and, if immobilized, need not be disposed in regular patterns or arrays. For convenience, the term “probe array” will generally be used broadly hereafter to refer to all of these types of arrays and parallel biological assays.

In one embodiment a method of mixing fluid is described that comprises providing a vibration comprising a resonant frequency; sympathetically amplifying the vibration in response to the resonant frequency; and modulating the resonant frequency, to cause the amplified vibration to generate turbulent flow in a fluid that influences the likelihood of interaction between a target molecule in the fluid with a probe on a biological probe array.

Also, a system for mixing fluid is described that comprises a vibration source that provides a vibration comprising a resonant frequency; resonant elements that sympathetically amplify the vibration in response to the resonant frequency; and an instrument control application that modulates the resonant frequency, where the modulated resonant frequency causes the amplified vibration to generate turbulent flow in a fluid that influences the likelihood of interaction between a target molecule in the fluid with a probe on a biological probe array.

Additionally, a system for mixing fluid is described that comprises a probe array that selectively hybridizes target molecules to associated probes disposed upon the probe array, where the plurality of target molecules are in a fluid; resonant elements positioned on a surface opposite the probe array each of which is responsive to a resonant frequency; and a vibration source that provides a first vibration comprising the resonant frequency, where the resonant elements vibrate sympathetically in response to the first vibration producing a second vibration comprising the resonant frequency that is amplified over the first vibration, and causes mixing of the fluid.

Further, a system for mixing fluid is described that comprises a processing instrument that accepts one or more housings each comprising a biological probe array and a plurality of resonant elements; and a computer comprising executable code stored in a system memory that performs the method of: instructing the processing instrument to provide a vibration comprising a resonant frequency, where the plurality of resonant elements sympathetically amplify the vibration in response to the resonant frequency; and instructing the processing instrument to modulate the resonant frequency, wherein the modulated resonant frequency causes the amplified vibration to generate turbulent flow in a fluid that influences the likelihood of interaction between a target molecule in the fluid with a probe on the biological probe array.

The above embodiments and implementations are not necessarily inclusive or exclusive of each other and may be combined in any manner that is non-conflicting and otherwise possible, whether they be presented in association with a same, or a different, embodiment or implementation. The description of one embodiment or implementation is not intended to be limiting with respect to other embodiments and/or implementations. Also, any one or more function, step, operation, or technique described elsewhere in this specification may, in alternative implementations, be combined with any one or more function, step, operation, or technique described in the summary. Thus, the above embodiment and implementations are illustrative rather than limiting.

### BRIEF DESCRIPTION OF THE DRAWINGS

The above and further features will be more clearly appreciated from the following detailed description when taken in conjunction with the accompanying drawings. In the drawings, like reference numerals indicate like structures or method steps and the leftmost digit of a reference numeral indicates the number of the figure in which the referenced element first appears (for example, the element 160 appears first in FIG. 1). In functional block diagrams, rectangles generally indicate functional elements and parallelograms generally indicate data. In method flow charts, rectangles generally indicate method steps and diamond shapes generally indicate decision elements. All of these conventions, however, are intended to be typical or illustrative, rather than limiting.

FIG. 1 is a functional block diagram of one embodiment of a probe array and probe array instrument system having a computer, a scanner, an autoloader, and a hybridization station;

FIG. 2 is a functional block diagram of one embodiment of the probe array, computer, scanner, autoloader, and hybridization station of FIG. 1;

FIG. 3 is a simplified graphical representation of a probe array housing having a hybridization chamber;

FIG. 4A is a simplified graphical representation of one embodiment of a resonant element insert having a plurality of resonant elements; and

FIG. 4B is a simplified graphical representation of one embodiment of the resonant elements of FIG. 4A in the hybridization chamber of FIG. 3.

### DETAILED DESCRIPTION OF THE INVENTION

Various embodiments are now described that are illustrative and not to be construed as limiting. For example, preferred embodiments may be described with respect to the use of resonant elements for mixing fluids for improved hybridization efficiency of target molecules to their associated probes disposed upon a probe array.

a) General

The present invention has many preferred embodiments and relies on many patents, applications and other references for details known to those of the art. Therefore, when a patent, application, or other reference is cited or repeated below, it should be understood that it is incorporated by reference in its entirety for all purposes as well as for the proposition that is recited.

As used in this application, the singular form “a,” “an,” and “the” include plural references unless the context clearly dictates otherwise. For example, the term “an agent” includes a plurality of agents, including mixtures thereof.

An individual is not limited to a human being but may also be other organisms including but not limited to mammals, plants, bacteria, or cells derived from any of the above.

Throughout this disclosure, various aspects of this invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

The practice of the present invention may employ, unless otherwise indicated, conventional techniques and descriptions of organic chemistry, polymer technology, molecular biology (including recombinant techniques), cell biology, biochemistry, and immunology, which are within the skill of the art. Such conventional techniques include polymer array synthesis, hybridization, ligation, and detection of hybridization using a label. Specific illustrations of suitable techniques can be had by reference to the example herein below. However, other equivalent conventional procedures can, of course, also be used. Such conventional techniques and descriptions can be found in standard laboratory manuals such as Genome Analysis: A Laboratory Manual Series (Vols. I-IV), Using Antibodies: A Laboratory Manual, Cells: A Laboratory Manual, PCR Primer: A Laboratory Manual, and Molecular Cloning: A Laboratory Manual (all from Cold Spring Harbor Laboratory Press), Stryer, L. (1995) Biochemistry (4th Ed.) Freeman, N.Y., Gait, “Oligonucleotide Synthesis: A Practical Approach” 1984, IRL Press, London, Nelson and Cox (2000), Lehninger, Principles of Biochemistry 3^{rd} Ed., W. H. Freeman Pub., New York, N.Y. and Berg et al. (2002) Biochemistry, 5th Ed., W. H. Freeman Pub., New York, N.Y., all of which are herein incorporated in their entirety by reference for all purposes.

The present invention can employ solid substrates, including arrays in some preferred embodiments. Methods and techniques applicable to polymer (including protein) array synthesis have been described in U.S. Ser. No. 09/536,841, WO 00/58516, U.S. Pat. Nos. 5,143,854, 5,242,974, 5,252,743, 5,324,633, 5,384,261, 5,405,783, 5,424,186, 5,451,683, 5,482,867, 5,491,074, 5,527,681, 5,550,215, 5,571,639, 5,578,832, 5,593,839, 5,599,695, 5,624,711, 5,631,734, 5,795,716, 5,831,070, 5,837,832, 5,856,101, 5,858,659, 5,936,324, 5,968,740, 5,974,164, 5,981,185, 5,981,956, 6,025,601, 6,033,860, 6,040,193, 6,090,555, 6,136,269, 6,269,846 and 6,428,752, in PCT Applications Nos. PCT/US99/00730 (International Publication Number WO 99/36760) and PCT/US01/04285 (International Publication Number WO 01/58593), which are all incorporated herein by reference in their entirety for all purposes.

Patents that describe synthesis techniques in specific embodiments include U.S. Pat. Nos. 5,412,087, 6,147,205, 6,262,216, 6,310,189, 5,889,165, and 5,959,098. Nucleic acid arrays are described in many of the above patents, but the same techniques are applied to polypeptide arrays.

Nucleic acid arrays that are useful in the present invention include those that are commercially available from Affymetrix (Santa Clara, Calif.) under the brand name GeneChip®. Example arrays are shown on the website at affymetrix.com.

The present invention also contemplates many uses for polymers attached to solid substrates. These uses include gene expression monitoring, profiling, library screening, genotyping and diagnostics. Gene expression monitoring and profiling methods can be shown in U.S. Pat. Nos. 5,800,992, 6,013,449, 6,020,135, 6,033,860, 6,040,138, 6,177,248 and 6,309,822. Genotyping and uses therefore are shown in U.S. Ser. Nos. 10/442,021, 10/013,598 (U.S. Patent Application Publication 20030036069), and U.S. Pat. Nos. 5,856,092, 6,300,063, 5,858,659, 6,284,460, 6,361,947, 6,368,799 and 6,333,179. Other uses are embodied in U.S. Pat. Nos. 5,871,928, 5,902,723, 6,045,996, 5,541,061, and 6,197,506.

The present invention also contemplates sample preparation methods in certain preferred embodiments. Prior to or concurrent with genotyping, the genomic sample may be amplified by a variety of mechanisms, some of which may employ PCR. See, e.g., PCR Technology: Principles and Applications for DNA Amplification (Ed. H. A. Erlich, Freeman Press, NY, N.Y., 1992); PCR Protocols: A Guide to Methods and Applications (Eds. Innis, et al., Academic Press, San Diego, Calif., 1990); Mattila et al., Nucleic Acids Res. 19, 4967 (1991); Eckert et al., PCR Methods and Applications 1, 17 (1991); PCR (Eds. McPherson et al., IRL Press, Oxford); and U.S. Pat. Nos. 4,683,202, 4,683,195, 4,800,159 4,965,188, and 5,333,675, and each of which is incorporated herein by reference in their entireties for all purposes. The sample may be amplified on the array. See, for example, U.S. Pat. No. 6,300,070 and U.S. Ser. No. 09/513,300, which are incorporated herein by reference.

Other suitable amplification methods include the ligase chain reaction (LCR) (e.g., Wu and Wallace, Genomics 4, 560 (1989), Landegren et al., Science 241, 1077 (1988) and Barringer et al. Gene 89:117 (1990)), transcription amplification (Kwoh et al., Proc. Natl. Acad. Sci. USA 86, 1173 (1989) and WO88/10315), self-sustained sequence replication (Guatelli et al., Proc. Nat. Acad. Sci. USA, 87, 1874 (1990) and WO90/06995), selective amplification of target polynucleotide sequences (U.S. Pat. No. 6,410,276), consensus sequence primed polymerase chain reaction (CP-PCR) (U.S. Pat. No. 4,437,975), arbitrarily primed polymerase chain reaction (AP-PCR) (U.S. Pat. No. 5,413,909, 5,861,245) and nucleic acid based sequence amplification (NABSA). (See, U.S. Pat. Nos. 5,409,818, 5,554,517, and 6,063,603, each of which is incorporated herein by reference). Other amplification methods that may be used are described in, U.S. Pat. Nos. 5,242,794, 5,494,810, 4,988,617 and in U.S. Ser. No. 09/854,317, each of which is incorporated herein by reference.

Additional methods of sample preparation and techniques for reducing the complexity of a nucleic sample are described in Dong et al., Genome Research 11, 1418 (2001), in U.S. Pat. Nos. 6,361,947, 6,391,592 and U.S. Ser. Nos. 09/916,135, 09/920,491 (U.S. Patent Application Publication 20030096235), Ser. No. 09/910,292 (U.S. Patent Application Publication 20030082543), and Ser. No. 10/013,598.

Methods for conducting polynucleotide hybridization assays have been well developed in the art. Hybridization assay procedures and conditions will vary depending on the application and are selected in accordance with the general binding methods known including those referred to in: Maniatis et al. Molecular Cloning: A Laboratory Manual (2^{nd} Ed. Cold Spring Harbor, N.Y., 1989); Berger and Kimmel Methods in Enzymology, Vol. 152, Guide to Molecular Cloning Techniques (Academic Press, Inc., San Diego, Calif., 1987); Young and Davism, P.N.A.S, 80: 1194 (1983). Methods and apparatus for carrying out repeated and controlled hybridization reactions have been described in U.S. Pat. Nos. 5,871,928, 5,874,219, 6,045,996 and 6,386,749, 6,391,623 each of which are incorporated herein by reference.

The present invention also contemplates signal detection of hybridization between ligands in certain preferred embodiments. See U.S. Pat. Nos. 5,143,854, 5,578,832; 5,631,734; 5,834,758; 5,936,324; 5,981,956; 6,025,601; 6,141,096; 6,185,030; 6,201,639; 6,218,803; and 6,225,625, in U.S. Ser. No. 10/389,194 and in PCT Application PCT/US99/06097 (published as WO99/47964), each of which also is hereby incorporated by reference in its entirety for all purposes.

Methods and apparatus for signal detection and processing of intensity data are disclosed in, for example, U.S. Pat. Nos. 5,143,854, 5,547,839, 5,578,832, 5,631,734, 5,800,992, 5,834,758; 5,856,092, 5,902,723, 5,936,324, 5,981,956, 6,025,601, 6,090,555, 6,141,096, 6,185,030, 6,201,639; 6,218,803; and 6,225,625, in U.S. Ser. Nos. 10/389,194, 60/493,495 and in PCT Application PCT/US99/06097 (published as WO99/47964), each of which also is hereby incorporated by reference in its entirety for all purposes.

The practice of the present invention may also employ conventional biology methods, software and systems. Computer software products of the invention typically include computer readable medium having computer-executable instructions for performing the logic steps of the method of the invention. Suitable computer readable medium include floppy disk, CD-ROM/DVD/DVD-ROM, hard-disk drive, flash memory, ROM/RAM, magnetic tapes and etc. The computer executable instructions may be written in a suitable computer language or combination of several languages. Basic computational biology methods are described in, e.g. Setubal and Meidanis et al., Introduction to Computational Biology Methods (PWS Publishing Company, Boston, 1997); Salzberg, Searles, Kasif, (Ed.), Computational Methods in Molecular Biology, (Elsevier, Amsterdam, 1998); Rashidi and Buehler, Bioinformatics Basics: Application in Biological Science and Medicine (CRC Press, London, 2000) and Ouelette and Bzevanis Bioinformatics: A Practical Guide for Analysis of Gene and Proteins (Wiley & Sons, Inc., 2^{nd} ed., 2001). See U.S. Pat. No. 6,420,108.

The present invention may also make use of various computer program products and software for a variety of purposes, such as probe design, management of data, analysis, and instrument operation. See, U.S. Pat. Nos. 5,593,839, 5,795,716, 5,733,729, 5,974,164, 6,066,454, 6,090,555, 6,185,561, 6,188,783, 6,223,127, 6,229,911 and 6,308,170.

Additionally, the present invention may have preferred embodiments that include methods for providing genetic information over networks such as the Internet as shown in U.S. Ser. Nos. 10/197,621, 10/063,559 (United States Publication No. 20020183936), Ser. Nos. 10/065,856, 10/065,868, 10/328,818, 10/328,872, 10/423,403, and 60/482,389.

b) Definitions

An “array” is an intentionally created collection of molecules which can be prepared either synthetically or biosynthetically. The molecules in the array can be identical or different from each other. The array can assume a variety of formats, e.g., libraries of soluble molecules; libraries of compounds tethered to resin beads, silica chips, or other solid supports.

Nucleic acid library or array is an intentionally created collection of nucleic acids which can be prepared either synthetically or biosynthetically and screened for biological activity in a variety of different formats (e.g., libraries of soluble molecules; and libraries of oligos tethered to resin beads, silica chips, or other solid supports). Additionally, the term “array” is meant to include those libraries of nucleic acids which can be prepared by spotting nucleic acids of essentially any length (e.g., from 1 to about 1000 nucleotide monomers in length) onto a substrate. The term “nucleic acid” as used herein refers to a polymeric form of nucleotides of any length, either ribonucleotides, deoxyribonucleotides or peptide nucleic acids (PNAs), that comprise purine and pyrimidine bases, or other natural, chemically or biochemically modified, non-natural, or derivatized nucleotide bases. The backbone of the polynucleotide can comprise sugars and phosphate groups, as may typically be found in RNA or DNA, or modified or substituted sugar or phosphate groups. A polynucleotide may comprise modified nucleotides, such as methylated nucleotides and nucleotide analogs. The sequence of nucleotides may be interrupted by non-nucleotide components. Thus the terms nucleoside, nucleotide, deoxynucleoside and deoxynucleotide generally include analogs such as those described herein. These analogs are those molecules having some structural features in common with a naturally occurring nucleoside or nucleotide such that when incorporated into a nucleic acid or oligonucleoside sequence, they allow hybridization with a naturally occurring nucleic acid sequence in solution. Typically, these analogs are derived from naturally occurring nucleosides and nucleotides by replacing and/or modifying the base, the ribose or the phosphodiester moiety. The changes can be tailor made to stabilize or destabilize hybrid formation or enhance the specificity of hybridization with a complementary nucleic acid sequence as desired.

Biopolymer or biological polymer: is intended to mean repeating units of biological or chemical moieties. Representative biopolymers include, but are not limited to, nucleic acids, oligonucleotides, amino acids, proteins, peptides, hormones, oligosaccharides, lipids, glycolipids, lipopolysaccharides, phospholipids, synthetic analogues of the foregoing, including, but not limited to, inverted nucleotides, peptide nucleic acids, Meta-DNA, and combinations of the above. “Biopolymer synthesis” is intended to encompass the synthetic production, both organic and inorganic, of a biopolymer. Related to a bioploymer is a “biomonomer” which is intended to mean a single unit of biopolymer, or a single unit which is not part of a biopolymer. Thus, for example, a nucleotide is a biomonomer within an oligonucleotide biopolymer, and an amino acid is a biomonomer within a protein or peptide biopolymer; avidin, biotin, antibodies, antibody fragments, etc., for example, are also biomonomers. initiation Biomonomer: or “initiator biomonomer” is meant to indicate the first biomonomer which is covalently attached via reactive nucleophiles to the surface of the polymer, or the first biomonomer which is attached to a linker or spacer arm attached to the polymer, the linker or spacer arm being attached to the polymer via reactive nucleophiles.

Complementary: Refers to the hybridization or base pairing between nucleotides or nucleic acids, such as, for instance, between the two strands of a double stranded DNA molecule or between an oligonucleotide primer and a primer binding site on a single stranded nucleic acid to be sequenced or amplified. Complementary nucleotides are, generally, A and T (or A and U), or C and G. Two single stranded RNA or DNA molecules are said to be complementary when the nucleotides of one strand, optimally aligned and compared and with appropriate nucleotide insertions or deletions, pair with at least about 80% of the nucleotides of the other strand, usually at least about 90% to 95%, and more preferably from about 98 to 100%. Alternatively, complementarity exists when an RNA or DNA strand will hybridize under selective hybridization conditions to its complement. Typically, selective hybridization will occur when there is at least about 65% complementary over a stretch of at least 14 to 25 nucleotides, preferably at least about 75%, more preferably at least about 90% complementary. See, M. Kanehisa Nucleic Acids Res. 12:203 (1984), incorporated herein by reference.

Combinatorial Synthesis Strategy: A combinatorial synthesis strategy is an ordered strategy for parallel synthesis of diverse polymer sequences by sequential addition of reagents which may be represented by a reactant matrix and a switch matrix, the product of which is a product matrix. A reactant matrix is a l column by m row matrix of the building blocks to be added. The switch matrix is all or a subset of the binary numbers, preferably ordered, between l and m arranged in columns. A “binary strategy” is one in which at least two successive steps illuminate a portion, often half, of a region of interest on the substrate. In a binary synthesis strategy, all possible compounds which can be formed from an ordered set of reactants are formed. In most preferred embodiments, binary synthesis refers to a synthesis strategy which also factors a previous addition step. For example, a strategy in which a switch matrix for a masking strategy halves regions that were previously illuminated, illuminating about half of the previously illuminated region and protecting the remaining half (while also protecting about half of previously protected regions and illuminating about half of previously protected regions). It will be recognized that binary rounds may be interspersed with non-binary rounds and that only a portion of a substrate may be subjected to a binary scheme. A combinatorial “masking” strategy is a synthesis which uses light or other spatially selective deprotecting or activating agents to remove protecting groups from materials for addition of other materials such as amino acids.

Effective amount refers to an amount sufficient to induce a desired result.

Genome is all the genetic material in the chromosomes of an organism. DNA derived from the genetic material in the chromosomes of a particular organism is genomic DNA. A genomic library is a collection of clones made from a set of randomly generated overlapping DNA fragments representing the entire genome of an organism.

Hybridization conditions will typically include salt concentrations of less than about 1M, more usually less than about 500 mM and preferably less than about 200 mM. Hybridization temperatures can be as low as 5.degree. C., but are typically greater than 22.degree. C., more typically greater than about 30.degree. C., and preferably in excess of about 37.degree. C. Longer fragments may require higher hybridization temperatures for specific hybridization. As other factors may affect the stringency of hybridization, including base composition and length of the complementary strands, presence of organic solvents and extent of base mismatching, the combination of parameters is more important than the absolute measure of any one alone.

Hybridizations, e.g., allele-specific probe hybridizations, are generally performed under stringent conditions. For example, conditions where the salt concentration is no more than about 1 Molar (M) and a temperature of at least 25 degrees-Celsius (° C.), e.g., 750 mM NaCl, 50 mM NaPhosphate, 5 mM EDTA, pH 7.4 (5X SSPE)and a temperature of from about 25 to about 30° C.

Hybridizations are usually performed under stringent conditions, for example, at a salt concentration of no more than 1 M and a temperature of at least 25° C. For example, conditions of 5X SSPE (750 mM NaCl, 50 mM NaPhosphate, 5 mM EDTA, pH 7.4) and a temperature of 25-30° C. are suitable for allele-specific probe hybridizations. For stringent conditions, see, for example, Sambrook, Fritsche and Maniatis. “Molecular Cloning A laboratory Manual” 2^{nd} Ed. Cold Spring Harbor Press (1989) which is hereby incorporated by reference in its entirety for all purposes above.

The term “hybridization” refers to the process in which two single-stranded polynucleotides bind non-covalently to form a stable double-stranded polynucleotide; triple-stranded hybridization is also theoretically possible. The resulting (usually) double-stranded polynucleotide is a “hybrid.” The proportion of the population of polynucleotides that forms stable hybrids is referred to herein as the “degree of hybridization.”

Hybridization probes are oligonucleotides capable of binding in a base-specific manner to a complementary strand of nucleic acid. Such probes include peptide nucleic acids, as described in Nielsen et al., Science 254, 1497-1500 (1991), and other nucleic acid analogs and nucleic acid mimetics.

Hybridizing specifically to: refers to the binding, duplexing, or hybridizing of a molecule only to a particular nucleotide sequence or sequences under stringent conditions when that sequence is present in a complex mixture (e.g., total cellular) DNA or RNA.

Isolated nucleic acid is an object species invention that is the predominant species present (i.e., on a molar basis it is more abundant than any other individual species in the composition). Preferably, an isolated nucleic acid comprises at least about 50, 80 or 90% (on a molar basis) of all macromolecular species present. Most preferably, the object species is purified to essential homogeneity (contaminant species cannot be detected in the composition by conventional detection methods).

Ligand: A ligand is a molecule that is recognized by a particular receptor. The agent bound by or reacting with a receptor is called a “ligand,” a term which is definitionally meaningful only in terms of its counterpart receptor. The term “ligand” does not imply any particular molecular size or other structural or compositional feature other than that the substance in question is capable of binding or otherwise interacting with the receptor. Also, a ligand may serve either as the natural ligand to which the receptor binds, or as a functional analogue that may act as an agonist or antagonist. Examples of ligands that can be investigated by this invention include, but are not restricted to, agonists and antagonists for cell membrane receptors, toxins and venoms, viral epitopes, hormones (e.g., opiates, steroids, etc.), hormone receptors, peptides, enzymes, enzyme substrates, substrate analogs, transition state analogs, cofactors, drugs, proteins, and antibodies.

Linkage disequilibrium or allelic association means the preferential association of a particular allele or genetic marker with a specific allele, or genetic marker at a nearby chromosomal location more frequently than expected by chance for any particular allele frequency in the population. For example, if locus X has alleles a and b, which occur equally frequently, and linked locus Y has alleles c and d, which occur equally frequently, one would expect the combination ac to occur with a frequency of 0.25. If ac occurs more frequently, then alleles a and c are in linkage disequilibrium. Linkage disequilibrium may result from natural selection of certain combination of alleles or because an allele has been introduced into a population too recently to have reached equilibrium with linked alleles.

Mixed population or complex population: refers to any sample containing both desired and undesired nucleic acids. As a non-limiting example, a complex population of nucleic acids may be total genomic DNA, total genomic RNA or a combination thereof. Moreover, a complex population of nucleic acids may have been enriched for a given population but include other undesirable populations. For example, a complex population of nucleic acids may be a sample which has been enriched for desired messenger RNA (mRNA) sequences but still includes some undesired ribosomal RNA sequences (rRNA).

Monomer: refers to any member of the set of molecules that can be joined together to form an oligomer or polymer. The set of monomers useful in the present invention includes, but is not restricted to, for the example of (poly)peptide synthesis, the set of L-amino acids, D-amino acids, or synthetic amino acids. As used herein, “monomer” refers to any member of a basis set for synthesis of an oligomer. For example, dimers of L-amino acids form a basis set of 400 “monomers” for synthesis of polypeptides. Different basis sets of monomers may be used at successive steps in the synthesis of a polymer. The term “monomer” also refers to a chemical subunit that can be combined with a different chemical subunit to form a compound larger than either subunit alone.

mRNA or mRNA transcripts: as used herein, include, but not limited to pre-mRNA transcript(s), transcript processing intermediates, mature mRNA(s) ready for translation and transcripts of the gene or genes, or nucleic acids derived from the mRNA transcript(s). Transcript processing may include splicing, editing and degradation. As used herein, a nucleic acid derived from an mRNA transcript refers to a nucleic acid for whose synthesis the mRNA transcript or a subsequence thereof has ultimately served as a template. Thus, a cDNA reverse transcribed from an mRNA, an RNA transcribed from that cDNA, a DNA amplified from the cDNA, an RNA transcribed from the amplified DNA, etc., are all derived from the mRNA transcript and detection of such derived products is indicative of the presence and/or abundance of the original transcript in a sample. Thus, mRNA derived samples include, but are not limited to, mRNA transcripts of the gene or genes, cDNA reverse transcribed from the mRNA, cRNA transcribed from the cDNA, DNA amplified from the genes, RNA transcribed from amplified DNA, and the like.

Nucleic acid library or array is an intentionally created collection of nucleic acids which can be prepared either synthetically or biosynthetically and screened for biological activity in a variety of different formats (e.g., libraries of soluble molecules; and libraries of oligos tethered to resin beads, silica chips, or other solid supports). Additionally, the term “array” is meant to include those libraries of nucleic acids which can be prepared by spotting nucleic acids of essentially any length (e.g., from 1 to about 1000 nucleotide monomers in length) onto a substrate. The term “nucleic acid” as used herein refers to a polymeric form of nucleotides of any length, either ribonucleotides, deoxyribonucleotides or peptide nucleic acids (PNAs), that comprise purine and pyrimidine bases, or other natural, chemically or biochemically modified, non-natural, or derivatized nucleotide bases. The backbone of the polynucleotide can comprise sugars and phosphate groups, as may typically be found in RNA or DNA, or modified or substituted sugar or phosphate groups. A polynucleotide may comprise modified nucleotides, such as methylated nucleotides and nucleotide analogs. The sequence of nucleotides may be interrupted by non-nucleotide components. Thus the terms nucleoside, nucleotide, deoxynucleoside and deoxynucleotide generally include analogs such as those described herein. These analogs are those molecules having some structural features in common with a naturally occurring nucleoside or nucleotide such that when incorporated into a nucleic acid or oligonucleoside sequence, they allow hybridization with a naturally occurring nucleic acid sequence in solution. Typically, these analogs are derived from naturally occurring nucleosides and nucleotides by replacing and/or modifying the base, the ribose or the phosphodiester moiety. The changes can be tailor made to stabilize or destabilize hybrid formation or enhance the specificity of hybridization with a complementary nucleic acid sequence as desired.
Nucleic acids according to the present invention may include any polymer or oligomer of pyrimidine and purine bases, preferably cytosine, thymine, and uracil, and adenine and guanine, respectively. See Albert L. Lehninger, PRINCIPLES OF BIOCHEMISTRY, at 793-800 (Worth Pub. 1982). Indeed, the present invention contemplates any deoxyribonucleotide, ribonucleotide or peptide nucleic acid component, and any chemical variants thereof, such as methylated, hydroxymethylated or glucosylated forms of these bases, and the like. The polymers or oligomers may be heterogeneous or homogeneous in composition, and may be isolated from naturally-occurring sources or may be artificially or synthetically produced. In addition, the nucleic acids may be DNA or RNA, or a mixture thereof, and may exist permanently or transitionally in single-stranded or double-stranded form, including homoduplex, heteroduplex, and hybrid states.

An “oligonucleotide” or “polynucleotide” is a nucleic acid ranging from at least 2, preferable at least 8, and more preferably at least 20 nucleotides in length or a compound that specifically hybridizes to a polynucleotide. Polynucleotides of the present invention include sequences of deoxyribonucleic acid (DNA) or ribonucleic acid (RNA) which may be isolated from natural sources, recombinantly produced or artificially synthesized and mimetics thereof. A further example of a polynucleotide of the present invention may be peptide nucleic acid (PNA). The invention also encompasses situations in which there is a nontraditional base pairing such as Hoogsteen base pairing which has been identified in certain tRNA molecules and postulated to exist in a triple helix. “Polynucleotide” and “oligonucleotide” are used interchangeably in this application.

Probe: A probe is a surface-immobilized molecule that can be recognized by a particular target. See U.S. Pat. No. 6,582,908 for an example of arrays having all possible combinations of probes with 10, 12, and more bases. Examples of probes that can be investigated by this invention include, but are not restricted to, agonists and antagonists for cell membrane receptors, toxins and venoms, viral epitopes, hormones (e.g., opioid peptides, steroids, etc.), hormone receptors, peptides, enzymes, enzyme substrates, cofactors, drugs, lectins, sugars, oligonucleotides, nucleic acids, oligosaccharides, proteins, and monoclonal antibodies.

Primer is a single-stranded oligonucleotide capable of acting as a point of initiation for template-directed DNA synthesis under suitable conditions e.g., buffer and temperature, in the presence of four different nucleoside triphosphates and an agent for polymerization, such as, for example, DNA or RNA polymerase or reverse transcriptase. The length of the primer, in any given case, depends on, for example, the intended use of the primer, and generally ranges from 15 to 30 nucleotides. Short primer molecules generally require cooler temperatures to form sufficiently stable hybrid complexes with the template. A primer need not reflect the exact sequence of the template but must be sufficiently complementary to hybridize with such template. The primer site is the area of the template to which a primer hybridizes. The primer pair is a set of primers including a 5′ upstream primer that hybridizes with the 5′ end of the sequence to be amplified and a 3′ downstream primer that hybridizes with the complement of the 3′ end of the sequence to be amplified.

Polymorphism refers to the occurrence of two or more genetically determined alternative sequences or alleles in a population. A polymorphic marker or site is the locus at which divergence occurs. Preferred markers have at least two alleles, each occurring at frequency of greater than 1%, and more preferably greater than 10% or 20% of a selected population. A polymorphism may comprise one or more base changes, an insertion, a repeat, or a deletion. A polymorphic locus may be as small as one base pair. Polymorphic markers include restriction fragment length polymorphisms, variable number of tandem repeats (VNTR's), hypervariable regions, minisatellites, dinucleotide repeats, trinucleotide repeats, tetranucleotide repeats, simple sequence repeats, and insertion elements such as Alu. The first identified allelic form is arbitrarily designated as the reference form and other allelic forms are designated as alternative or variant alleles. The allelic form occurring most frequently in a selected population is sometimes referred to as the wildtype form. Diploid organisms may be homozygous or heterozygous for allelic forms. A dialleic polymorphism has two forms. A triallelic polymorphism has three forms. Single nucleotide polymorphisms (SNPs) are included in polymorphisms.

Receptor: A molecule that has an affinity for a given ligand. Receptors may be naturally-occurring or manmade molecules. Also, they can be employed in their unaltered state or as aggregates with other species. Receptors may be attached, covalently or noncovalently, to a binding member, either directly or via a specific binding substance. Examples of receptors which can be employed by this invention include, but are not restricted to, antibodies, cell membrane receptors, monoclonal antibodies and antisera reactive with specific antigenic determinants (such as on viruses, cells or other materials), drugs, polynucleotides, nucleic acids, peptides, cofactors, lectins, sugars, polysaccharides, cells, cellular membranes, and organelles. Receptors are sometimes referred to in the art as anti-ligands. As the term receptors is used herein, no difference in meaning is intended. A “Ligand Receptor Pair” is formed when two macromolecules have combined through molecular recognition to form a complex. Other examples of receptors which can be investigated by this invention include but are not restricted to those molecules shown in U.S. Pat. No. 5,143,854, which is hereby incorporated by reference in its entirety.

“Solid support”, “support”, and “substrate” are used interchangeably and refer to a material or group of materials having a rigid or semi-rigid surface or surfaces. In many embodiments, at least one surface of the solid support will be substantially flat, although in some embodiments it may be desirable to physically separate synthesis regions for different compounds with, for example, wells, raised regions, pins, etched trenches, or the like. According to other embodiments, the solid support(s) will take the form of beads, resins, gels, microspheres, or other geometric configurations. See U.S. Pat. No. 5,744,305 for exemplary substrates.

Target: A molecule that has an affinity for a given probe. Targets may be naturally-occurring or man-made molecules. Also, they can be employed in their unaltered state or as aggregates with other species. Targets may be attached, covalently or noncovalently, to a binding member, either directly or via a specific binding substance. Examples of targets which can be employed by this invention include, but are not restricted to, antibodies, cell membrane receptors, monoclonal antibodies and antisera reactive with specific antigenic determinants (such as on viruses, cells or other materials), drugs, oligonucleotides, nucleic acids, peptides, cofactors, lectins, sugars, polysaccharides, cells, cellular membranes, and organelles. Targets are sometimes referred to in the art as anti-probes. As the term targets is used herein, no difference in meaning is intended. A “Probe Target Pair” is formed when two macromolecules have combined through molecular recognition to form a complex.

c) Embodiments of the Invention

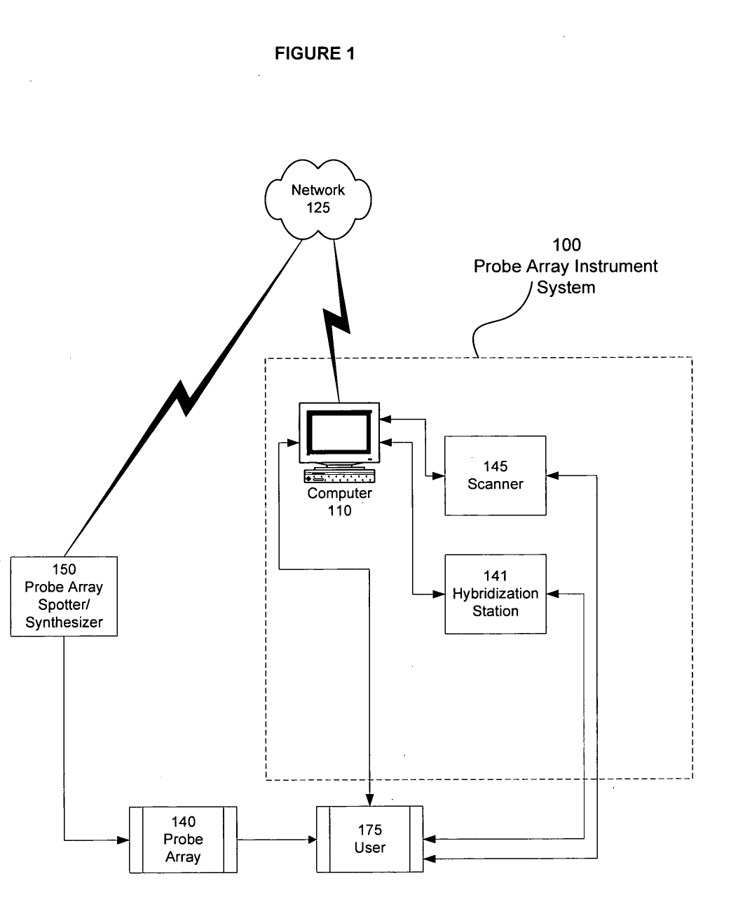

Probe Array Spotter/Synthesizer 150: Some embodiments of the present invention may include one or more elements produced by various methods and technologies, such as for example by an embodiment of probe array spotter/synthesizer 150. An illustrative embodiment of a microarray spotting or synthesizing instrument is presented in FIG. 1 as probe array spotter/synthesizer 150. In the illustrative example of FIG. 1, probe array 140 is produced by spotter/synthesizer 150 that may comprise an internal computer with memory, or alternatively receive instructions from an external computer such as computer 110. Computer 110 could communicate with spotter/synthesizer 150 via a variety of methods known in the art such as a “hard wire” type of connection, local area network, wide area network, wireless network (sometimes referred to as Wifi), or other network type connection that may, for instance, be represented in FIG. 1 as network 125. In the present example probe array 140 could be a spotted probe array or a synthesized probe array. Methods for producing synthesized or spotted arrays are described above with respect to “Nucleic acid arrays” or “Polypeptide arrays”.

Some embodiments of spotter/synthesizer 150 may be enabled to produce a plurality of probe arrays in a high throughput fashion. For example, spotter/synthesizer 150 may produce a plurality of probe arrays 140 simultaneously. For instance, some probe arrays may be produced in parallel where spotter/synthesizer 150 separately produces a plurality of arrays on individual glass slides, wafers, or other type of substrate. Alternatively, probe arrays 140 may be produced by various methods of probe deposition onto a single substrate that then may be diced or divided into individual implementations of probe array 140. In the present example, some implementations of spotter/synthesizer 150 may produce a number of probe arrays that is user selectable via computer 110 or alternatively it may be a predefined value stored in a data structure or file such as, for instance probe array data 223, and executed via computer 110, server, or other computer as described in greater detail below.

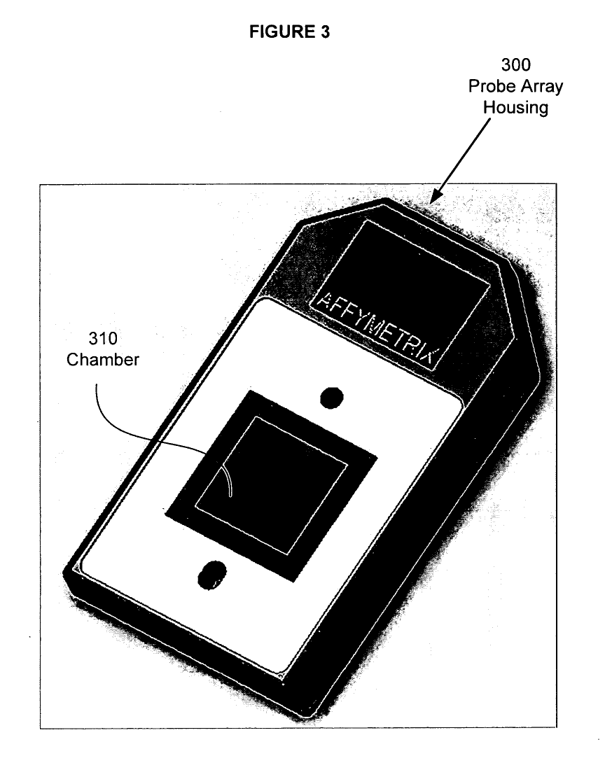

Additionally, some embodiments of spotter/synthesizer 150 may be enabled to house each implementation of probe array 140 in a cartridge or housing, such as the illustrative example of probe array housing 300 presented in FIG. 3. Other examples of housing 300 may include a cover that interfaces with the substrate of probe array 140 creating a fluid tight chamber, a cuvette that comprises an embodiment of probe array 140, a well plate with a plurality of wells each defining a chamber one or more of which comprises an embodiment of probe array 140, where each embodiment of housing 300 may also comprise one or more fluid apertures, openings, or interfaces for the addition and removal of fluids from the chamber defined by housing 300. In the previously described examples, it may be advantageous that some implementations of housing 300 be inexpensive to manufacture an employ where in some implementations user 175 would dispose of housing 300 after a single use. Some embodiments of housing 300 may include a housing that permanently or temporarily encloses probe array 140, and in some implementations housing 300 may be enabled to accept one or more removable elements. For example, one possible embodiment may include an implementation of housing 300 comprising one face such as a window or opaque face opposite of the probe array is removable. Alternatively, it may be advantageous in some embodiments to remove the probe array from the housing or housing from probe array. In the present example, the array may be scanned without liquid or other medium that may cause various degrees of optical distortion.

Spotter/synthesizer 150 may also work with an autoloader implementation or other type of instrument such as for instance, one or more types of robotic device known to those in the art for transporting slides, trays, plates, cuvettes, cartridges, or other similar types of elements. One embodiment of autoloader or device may automatically remove one or more spotted or synthesized probe arrays from spotter/synthesizer 150 and load them into a carousel or magazine that may then be ready for use in a high throughput format. In an alternative embodiment, spotter/synthesizer 150 may perform the functions of placing the probe arrays in the carousel or magazine. In the two embodiments described above, spotter/synthesizer 150 may be located remotely from probe array instrument system 100 where a carousel containing a plurality of probe arrays 140 may be transported to system 100 for processing and analysis. Alternatively, spotter/synthesizer 150 may be directly associated with system 100 so that the process of producing, processing, and analyzing probe arrays 140 may be accomplished as a seamless process. For example, an autoloader may also act as an intermediary between spotter/synthesizer 150 and probe array instrument system 100, or alternatively act as an intermediary between elements of system 100 such as hybridization station 141 and scanner 145.

Some embodiments of spotter/synthesizer 150 may include systems and methods for reading and/or assigning barcode identifiers or other type of identifier such as, for instance, other means of electronic or optically based identification such as magnetic strips, what are referred to by those of ordinary skill in the related art as radio frequency identification (RFID), or other means of encoding information in a machine readable or identifiable format. For example, spotter/synthesizer 150 may apply a barcode or RFID element associated with one or more identifiers to one or more implementations of probe array 140 or housing 300 using techniques known to those of ordinary skill in the related art such as, for instance, affixing a RFID tag, label, printing, or other type of method for labeling. In the present example, the identifiers may be comprised of one or more elements that could include unique identifiers, probe array type, lot number, expiration date, user identifiers, one or more experimental parameters such as one or more resonant frequencies or ranges of frequencies associated with of one or more types or areas of and an embodiment of resonant element 405, or other type of associated information. Additionally in the present example some embodiments of RFID elements may be enabled to store information in real-time where, for instance, instruments such as hybridization station 141, scanner 145, or other instrument could be enabled to write information to an RFID element that could be used later in trouble shooting, experiment or sample tracking, normalization of data, or other types of analysis.

In some embodiments, computer 110 may assign one or more elements of an identifier for each implementation of probe array 140 such as, for instance, a unique identifier, and create database records, experiment files, or other type of data structure that may contain the identifier(s), one or more elements of the identifiers, and associated information that may be retrieved based, at least in part, upon one or more of the elements of the identifiers. Computer 110 may then forward the database records and/or experiments files to a LIMS system, or other remote server or storage device. Alternatively, computer 110 may store the database records and/or experiment files locally such as, for instance, in probe array data 223, or on computer readable storage media such as a floppy disk, CD-ROM, or other type of removable storage.

Those of ordinary skill in the related art will appreciate that the instruments and functions described with respect to Probe array spotter/synthesizer 150 are for the purpose of illustration only and should not be considered limiting in any way. Those of ordinary skill in the related art will appreciate that implementations of spotter/synthesizer 150 may be employed in a laboratory, factory, or other type of environment for producing probe arrays, housings, or any of the elements described above. Additionally, probe arrays 140 may be commercially available and distributed to user 175 by commonly used methods. For example, the described functions need not be performed by a single instrument but rather may be performed by a plurality of instruments that need not be located in close proximity to one another but rather one or more may be located remotely from a first instrument.

Hybridization station141: Illustrated in FIG. 1 is hybridization station 141 that may, in some embodiments, be a component of probe array instrument system 100. In some embodiments, station 141 may implement methods and procedures for processing biological probe arrays, such as for example, exposing each of the probe arrays to one or more biological samples, providing temperature control, and providing mixing means such as those that will be described in detail below with respect to resonant element 400 and insert 405. Additional operations performed by station 141 may also include processing steps known to those of ordinary skill in the related art such as washing, staining, drying, or other probe array processing step required prior to scanning.

Station 141 may include a plurality of elements enabled to introduce and/or remove a sample, washes, buffers, stains, or other types of fluid into housing 300 through one or more specialized ports, apertures, openings, and/or interfaces. For example, executables 299A may direct station 141 to add a specified volume of a particular sample to a chamber within an associated implementation of probe array housing 300. Station 141 removes the specified volume of sample from a reservoir positioned in a sample holder via one of sample transfer pins or other means of transfer. In the present example, the sample holder may be thermally controlled in order to maintain the biological integrity of the samples contained in the reservoirs. The term “reservoir” as used herein could include a vial, tube, bottle, or some other container suitable for holding volumes of liquid. Also in the present example, station 141 may employ a vacuum/pressure source, valves, and means for fluid transport known to those of ordinary skill in the related art.

Alternatively, some embodiments of station 141 may be enabled to transfer a sample using a pin or needle that removes a sample from the reservoir and directly transfers the sample to probe array 140.

Some embodiments of station 141 provides an environment that promotes the hybridization of a biological target contained in a sample to the probes of the probe array. Some environmental conditions that affect the hybridization efficiency could include temperature, gas bubbles, agitation, oscillating fluid levels, or other conditions that could promote the hybridization of biological samples to probes, or mixing of fluids within a chamber such as those that are described in detail below with respect to resonant element 400 and insert 405.

As previously described, some embodiments of station 141 may also perform what those of ordinary skill in the related art may refer to as post hybridization operations such as, for instance, washes with buffers or reagents, water, stains, labels, or antibodies. For example, staining may include introducing molecules with fluorescent tags that selectively bind to the biological molecules or targets that have hybridized to probe array 140. In the present example, one or more fluorescently tagged molecules may bind to each probe/target pair where each additional fluorescent molecule that binds increases the intensity of emitted light during scanning. Also, the process of staining could include exposure of the hybridized probe array to molecules with fluorescent tags with different characteristics such as molecules that selectively bind to a specific hybridized probe target pairs, or a variety of fluorescent tags with different excitation and emission properties. For instance, a first fluorescent tag may become excited when exposed to a first wavelength of light and emit light at a second wavelength. A second fluorescent tag may be in close enough proximity to the first fluorescent tag and become excited by the second wavelength of light, and emit a third wavelength of light.

Station 141 may also perform operations that do not act directly upon a probe array. Such functions could include the management of fresh versus used reagents and buffers, experimental samples, or other materials utilized in hybridization operations. Additionally, station 141 may include features for leak control and isolation from systems that may be sensitive to exposure to liquids. For example, a user may load a variety of experimental samples into station 141 that have unique experimental requirements. In the present example the samples may have barcode, RFID or other types of labels comprising unique identifiers associated with them. In some embodiments, the labels could be scanned with a hand held reader or alternatively station 141 could include an internal or external reader. In some embodiments, the user or executables 299A may associate an identifier with a sample and store the data into one or more data files that for example could include probe array data 223. The sample may also be associated with a specific probe array type that is similarly stored.

Additional examples of instruments employed for hybridization, washing staining and other fluid handling activities are described in U.S. patent application Ser. No. 10/684,160, titled “Integrated High-Throughput Microarray System and Process”, filed Oct. 10, 2003; and Ser. No. 10/712,860, titled “AUTOMATED FLUID CONTROL SYSTEM AND PROCESS”, filed Nov. 13, 2003, both of which are hereby incorporated by reference herein in its entirety for all purposes.

Scanner 145: FIG. 1 also presents an illustrative example of scanner 145 that in some embodiments provides excitation light and collects emitted light from probe array 140 that is converted into emission signals that may be incorporated into an image or other type of data. Some embodiments of scanner 145 are enabled to detect hybridized probe-target pairs by detecting fluorescent, radioactive, or other emissions; by detecting transmitted, reflected, or scattered radiation; by detecting electromagnetic properties or characteristics; or by other techniques. Also generally included are various light-detector systems employing photodiodes, charge-coupled devices, photomultiplier tubes, or similar devices to register the collected emissions. Illustrative scanners or scanning systems that, in various implementations, may include scanner 145 are described in U.S. Pat. Nos. 5,143,854, 5,578,832, 5,631,734, 5,834,758, 5,936,324, 5,981,956, 6,025,601, 6,141,096, 6,185,030, 6,201,639, 6,218,803, 6,252,236, 6,545,264, 6,643,015, 6,490,533, 6,650,411, 6,813,567, and 6,829,376; in PCT Application PCT/US99/06097 (published as WO99/47964); in U.S. patent application Ser. Nos. 10/913,102, 10/623,883, 10/389,194; and in U.S. Provisional patent application Ser. No. 60/623,390, each of which is hereby incorporated herein by reference in its entirety for all purposes.

Labeled targets hybridized to probe arrays may be detected using various devices, sometimes referred to as scanners, as described above with respect to methods and apparatus for signal detection. For example, scanners image the targets by detecting fluorescent or other emissions from labels associated with target molecules, or by detecting transmitted, reflected, or scattered radiation. A typical scheme employs optical and other elements to provide excitation light and to selectively collect the emissions.

For example, scanner 145 provides a signal representing the intensities (and possibly other characteristics, such as color that may be associated with a detected wavelength) of the detected emissions or reflected wavelengths of light, as well as the locations on the substrate where the emissions or reflected wavelengths were detected. Typically, the signal includes intensity information corresponding to elemental sub-areas of the scanned substrate. The term “elemental” in this context means that the intensities, and/or other characteristics, of the emissions or reflected wavelengths from this area each are represented by a single value. When displayed as an image for viewing or processing, elemental picture elements, or pixels, often represent this information. Thus, in the present example, a pixel may have a single value representing the intensity of the elemental sub-area of the substrate from which the emissions or reflected wavelengths were scanned. The pixel may also have another value representing another characteristic, such as color, positive or negative image, or other type of image representation. The size of a pixel may vary in different embodiments and could include a 2.5 μm, 1.5 μm, 1.0 μm, or sub-micron pixel size. Two examples where the signal may be incorporated into data are data files in the form *.dat or *.tif as generated respectively by Affymetrix® Microarray Suite (described in U.S. patent application Ser. No. 10/219,882, which is hereby incorporated by reference herein in its entirety for all purposes) or Affymetrix® GeneChip® Operating Software (described in U.S. patent application Ser. No. 10/764,663, which is hereby incorporated by reference herein in its entirety for all purposes ) based on images scanned from GeneChip® arrays, and Affymetrix® Jaguar™ software (described in U.S. patent application Ser. No. 09/682,071, which is hereby incorporated by reference herein in its entirety for all purposes) based on images scanned from spotted arrays. Examples of scanner systems that may be implemented with embodiments of the present invention include U.S. patent application Ser. No. 10/389,194, 10/846,261, and 10/913,102 each of which are incorporated by reference above.

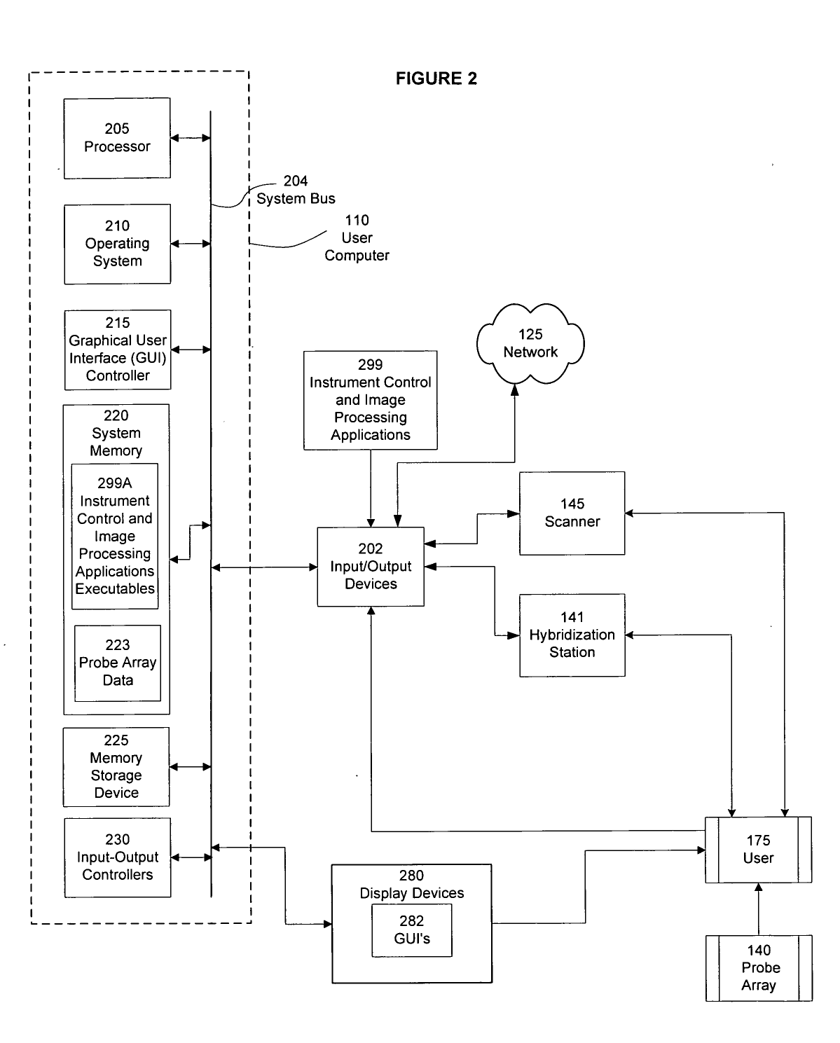

User Computer 110: An illustrative example of computer 110 is provided in FIG. 1 and also in greater detail in FIG. 2. Computer 110 may be any type of computer platform such as a workstation, a personal computer, a server, or any other present or future computer. Computer 110 typically includes known components such as a processor 205, an operating system 210, system memory 220, memory storage devices 225, and input-output controllers 230, input/output devices 202, and display devices 280. Display devices 280 may include display devices that provides visual information, this information typically may be logically and/or physically organized as an array of pixels. A Graphical user interface (GUI) controller may also be included that may comprise any of a variety of known or future software programs for providing graphical input and output interfaces such as for instance GUI's 282. For example, GUI's 282 may provide one or more graphical representations to a user, such as user 175, and also be enabled to process user inputs via GUI's 282 using means of selection or input known to those of ordinary skill in the related art.

It will be understood by those of ordinary skill in the relevant art that there are many possible configurations of the components of computer 110 and that some components that may typically be included in computer 110 are not shown, such as cache memory, a data backup unit, and many other devices. Processor 205 may be a commercially available processor such as an Itanium® or Pentium® processor made by Intel Corporation, a SPARC® processor made by Sun Microsystems, an Athalon™ or Opteron™ processor made by AMD corporation, or it may be one of other processors that are or will become available. Processor 205 executes operating system 210, which may be, for example, a Windows®-type operating system (such as Windows NT® 4.0 with SP6a, or Windows XP) from the Microsoft Corporation; a Unix® or Linux-type operating system available from many vendors or what is referred to as an open source; another or a future operating system; or some combination thereof. Operating system 210 interfaces with firmware and hardware in a well-known manner, and facilitates processor 205 in coordinating and executing the functions of various computer programs that may be written in a variety of programming languages. Operating system 210, typically in cooperation with processor 205, coordinates and executes functions of the other components of computer 110. Operating system 210 also provides scheduling, input-output control, file and data management, memory management, and communication control and related services, all in accordance with known techniques.

System memory 220 may be any of a variety of known or future memory storage devices. Examples include any commonly available random access memory (RAM), magnetic medium such as a resident hard disk or tape, an optical medium such as a read and write compact disc, or other memory storage device. Memory storage devices 225 may be any of a variety of known or future devices, including a compact disk drive, a tape drive, a removable hard disk drive, or a diskette drive. Such types of memory storage devices 225 typically read from, and/or write to, a program storage medium (not shown) such as, respectively, a compact disk, magnetic tape, removable hard disk, or floppy diskette. Any of these program storage media, or others now in use or that may later be developed, may be considered a computer program product. As will be appreciated, these program storage media typically store a computer software program and/or data. Computer software programs, also called computer control logic, typically are stored in system memory 220 and/or the program storage device used in conjunction with memory storage device 225.

In some embodiments, a computer program product is described comprising a computer usable medium having control logic (computer software program, including program code) stored therein. The control logic, when executed by processor 205, causes processor 205 to perform functions described herein. In other embodiments, some functions are implemented primarily in hardware using, for example, a hardware state machine. Implementation of the hardware state machine so as to perform the functions described herein will be apparent to those skilled in the relevant arts.

Input-output controllers 230 could include any of a variety of known devices for accepting and processing information from a user, whether a human or a machine, whether local or remote. Such devices include, for example, modem cards, network interface cards, sound cards, or other types of controllers for any of a variety of known input devices. Output controllers of input-output controllers 230 could include controllers for any of a variety of known display devices for presenting information to a user, whether a human or a machine, whether local or remote. In the illustrated embodiment, the functional elements of computer 110 communicate with each other via system bus 204. Some of these communications may be accomplished in alternative embodiments using network or other types of remote communications.

As will be evident to those skilled in the relevant art, instrument control and image processing applications 299, if implemented in software, may be loaded into and executed from system memory 220 and/or memory storage device 225. All or portions of applications 299 may also reside in a read-only memory or similar device of memory storage device 225, such devices not requiring that applications 299 first be loaded through input-output controllers 230. It will be understood by those skilled in the relevant art that applications 299, or portions of it, may be loaded by processor 205 in a known manner into system memory 220, or cache memory (not shown), or both, as advantageous for execution. Also not illustrated are library files, calibration data, and experiment data each of which may be stored in system memory 220. For example, calibration data could include one or more values or other types of calibration data related to the calibration of scanner 145 or other instrument. Additionally, experiment data could include data related to one or more experiments or assays such as excitation wavelength ranges, emission wavelength ranges, extinction coefficients and/or associated excitation power level values, or other values associated with one or more fluorescent labels.

Network 125 may include one or more of the many various types of networks well known to those of ordinary skill in the art. For example, network 125 may include what is commonly referred to as a TCP/IP network, or other type of network that may include the internet, or intranet architectures.

Instrument Control and Image Processing Applications 299: Instrument control and image processing applications 299 may be any of a variety of known or future image processing applications. Examples of applications 299 include Affymetrix® Microarray Suite, Affymetrix® GeneChip® Operating Software (hereafter referred to as GCOS), and Affymetrix® Jaguar™ software, noted above. Applications 299 may be loaded into system memory 220 and/or memory storage device 281 through one of input devices 240.

Embodiments of applications 299 include executable code being stored in system memory 220 of an implementation of computer 145, illustrated in FIG. 2 as instrument control and image processing applications 299A. Applications 299 may provide a single interface for both the client workstation and one or more servers such as, for instance, GeneChip® Operating Software Server (GCOS Server). Applications 299 could additionally provide the single user interface for one or more other workstations and/or one or more instruments. In the presently described implementation, the single interface may communicate with and control one or more elements of the one or more servers, one or more workstations, and the one or more instruments. In the described implementation the client workstation could be located locally or remotely to the one or more servers and/or one or more other workstations, and/or one or more instruments. The single interface may, in the present implementation, include an interactive graphical user interface that allows a user to make selections based upon information presented in the GUI. For example, applications 299 may provide an interactive GUI that allows a user to select from a variety of options including data selection, experiment parameters, calibration values, probe array information, or instrument parameters that could include the operations of separate elements within an instrument. Applications 299 may also provide a graphical representation of raw or processed image data where the processed image data may also include annotation information superimposed upon the image such as, for instance, base calls, features of the probe array, or other useful annotation information. Further examples of providing annotation information on image data are provided in U.S. Provisional Patent Application Ser. No. 60/493,950, titled “System, Method, and Product for Displaying Annotation Information Associated with Microarray Image Data”, filed Aug. 8, 2003, which is hereby incorporated by reference herein in its entirety for all purposes.

In alternative implementations, applications 299 may be executed on a server, or on one or more other computer platforms connected directly or indirectly (e.g., via another network, including the Internet or an Intranet) to network 125.

Embodiments of applications 299 also include instrument control features. The instrument control features may include the control of one or more elements of one or more instruments that could, for instance, include elements of a fluidics station, what may be referred to as an autoloader, and scanner 100. The instrument control features may also be capable of receiving information from the one more instruments that could include experiment or instrument status, process steps, or other relevant information. The instrument control features could, for example, be under the control of or an element of the single interface. In the present example, a user may input desired control commands and/or receive the instrument control information via one of GUI's 246. Additional examples of instrument control via a GUI or other interface is provided in U.S. patent application Ser. No. 10/764,663, titled “System, Method and Computer Software Product for Instrument Control, Data Acquisition, Analysis, Management and Storage”, filed Jan. 26, 2004, which is hereby incorporated by reference herein in its entirety for all purposes.

In some embodiments, image data is operated upon by applications 299 to generate intermediate results. Examples of intermediate results include so-called cell intensity files (*.cel) and chip files (*.chp) generated by Affymetrix® GeneChip® Operating Software or Affymetrix® Microarray Suite (as described, for example, in U.S. patent application Ser. Nos. 10/219,882, and 10/764,663, both of which are hereby incorporated herein by reference in their entireties for all purposes) and spot files (*.spt) generated by Affymetrix® Jaguar™ software (as described, for example, in PCT Application PCT/US 01/26390 and in U.S. patent application Ser. Nos. 09/681,819, 09/682,071, 09/682,074, and 09/682,076, all of which are hereby incorporated by reference herein in their entireties for all purposes). For convenience, the term “file” often is used herein to refer to data generated or used by applications 299 and executable counterparts of other applications, but any of a variety of alternative techniques known in the relevant art for storing, conveying, and/or manipulating data may be employed.

For example, applications 299 receives image data derived from a GeneChip® probe array and generates a cell intensity file. This file contains, for each probe scanned by scanner 145, a single value representative of the intensities of pixels measured by scanner 145 for that probe. Thus, this value is a measure of the abundance of tagged mRNA's present in the target that hybridized to the corresponding probe. Many such mRNA's may be present in each probe, as a probe on a GeneChip® probe array may include, for example, millions of oligonucleotides designed to detect the mRNA's. As noted, another file illustratively assumed to be generated by applications 299 is a chip file. In the present example, in which applications 299 include Affymetrix® GeneChip® Operating Software, the chip file is derived from analysis of the cell file combined in some cases with information derived from lab data and/or library files that specify details regarding the sequences and locations of probes and controls. The resulting data stored in the chip file includes degrees of hybridization, absolute and/or differential (over two or more experiments) expression, genotype comparisons, detection of polymorphisms and mutations, and other analytical results.

In another example, in which applications 299 includes Affymetrix® Jaguar™ software operating on image data from a spotted probe array, the resulting spot file includes the intensities of labeled targets that hybridized to probes in the array. Further details regarding cell files, chip files, and spot files are provided in U.S. patent application Ser. No. 09/682,074 incorporated by reference above, as well as Ser. Nos. 10/126,468; and 09/682,098; which are hereby incorporated by reference herein in their entireties for all purposes. As will be appreciated by those skilled in the relevant art, the preceding and following descriptions of files generated by applications 299 are exemplary only, and the data described, and other data, may be processed, combined, arranged, and/or presented in many other ways.

User 175 and/or automated data input devices or programs (not shown) may provide data related to the design or conduct of experiments. As one further non-limiting example related to the processing of an Affymetrix® GeneChip® probe array, the user may specify an Affymetrix catalogue or custom chip type (e.g., Human Genome U133 plus 2.0 chip) either by selecting from a predetermined list presented by GCOS or by scanning a bar code, Radio Frequency Identification (RFID), or other means of electronic identification related to a chip to read its type. Applications 299 may associate the chip type with various scanning parameters stored in data tables including the area of the chip that is to be scanned, the location of chrome borders on the chip used for auto-focusing, the wavelength or intensity/power of excitation light to be used in reading the chip, and so on. As noted, applications 299 may apply some of this data in the generation of intermediate results. For example, information about the dyes may be incorporated into determinations of relative expression.

Those of ordinary skill in the related art will appreciate that one or more operations of applications 299 may be performed by software or firmware associated with various instruments. For example, scanner 145 could include a computer that may include a firmware component that performs or controls one or more operations associated with scanner 145.

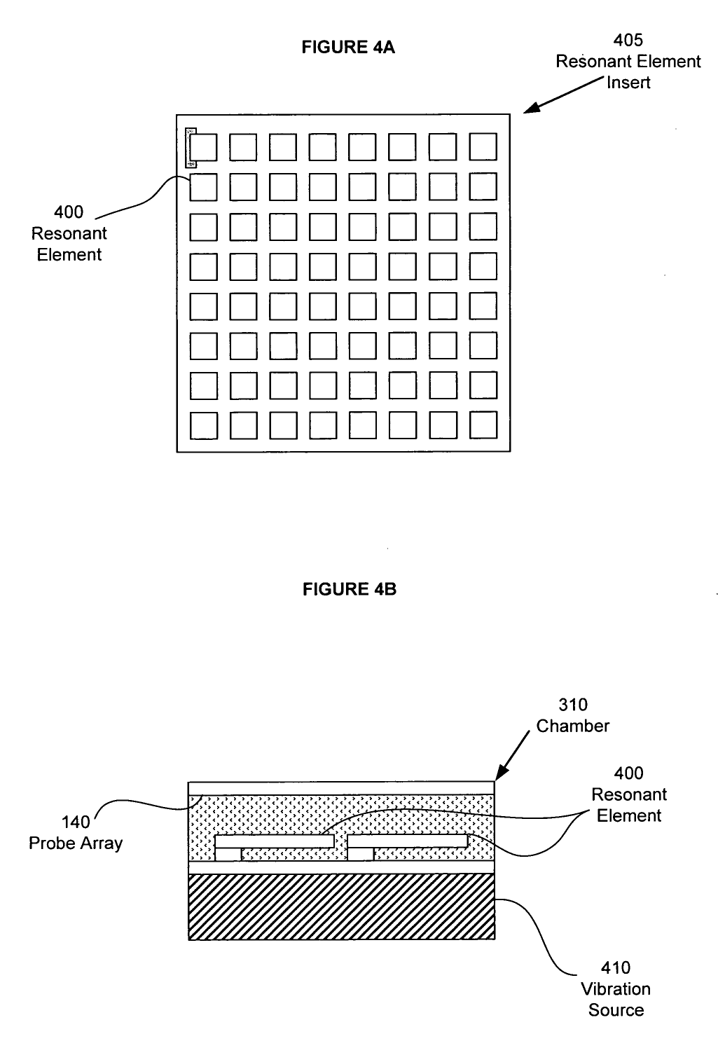

Resonant Element 400: FIG. 4A provides an illustrative example of a plurality of resonant elements 400 manufactured or disposed upon a substrate such as resonant element insert 405 that may be incorporated into a chamber. In some embodiments, each of resonant elements sympathetically resonates in response to input vibrations of a particular frequency or range of frequencies, where the sympathetic resonation acts to amplify the input vibrations. The term “sympathetic” as used herein generally refers to the effect of a vibration produced in one body by the vibrations of the same frequency in a neighboring body. Embodiments of resonant element insert 405 may have several advantages such as the ability to provide turbulent fluid flow and resultant mixing of fluids, low cost of manufacture, a reduction in the number of required instruments for experimental processes and procedures, and increased efficiency of one or more experimental processes or procedures.

Some embodiments of housing 300 may include one or more elements, such as resonant elements 400 manufactured as part of housing 300 or incorporated onto a substrate such as insert 405. Embodiments of resonant element 400 are enabled to create a flow of liquids within one or more cavities or chambers defined by housing 300 such as, for instance, chamber 310. It may be advantageous in many embodiments that the elements 400 are positionally located within chamber 310 so that, for instance, the elements may efficiently transfer energy to the fluid and may require less overall energy input to stimulate fluid flow. Further examples of chambers, cartridges and housings are described in U.S. Pat. Ser. Nos. 5,945,334, 6,287,850, 6,399,365, 6,551,817, 6,733,977, each of which are hereby incorporated by reference herein in it's entirety for all purposes.

In some embodiments the arrangement of a plurality of elements 400 in chamber 310 may be enabled to create a turbulent or chaotic flow of fluids or other type of flow where a fluid experiences momentum changes in irregular ways. For example, it may be desirable to stimulate to movement of fluids within chamber 310 to break up or penetrate what may be referred to as a “boundary layer” that those of ordinary skill in the art appreciate is commonly associated with what may be referred to as laminar type flow over a surface such as the surface of probe array 140. The term “boundary layer” as used herein generally refers to a thin layer of fluid near the surface where the velocity of fluid flow at the fluid/surface interface is zero and increases proportionally with distance away from the surface until the velocity reaches the velocity of fluid flow outside of the boundary layer. Thus there is little or no mixing of fluids at the surface with zero velocity. In the present example, turbulent or chaotic mixing may break up or penetrate the boundary layer and influences the likelihood of contact or interaction between target molecules in a sample with the probes disposed upon probe array 140. Such an influence may be to increase or optimize the likelihood of the contact or interaction. In many implementations the increased likelihood and resultant increase in the rate of interaction may improve the efficiency of probe/target hybridization, labeling of hybridized probe/target pairs, and other related processing steps, thus reducing processing time and may also increase the sensitivity of probe array 140 that in other words increases the ability to detect target molecules especially those that are present in small numbers or low concentration. Additional benefits may also include the need for smaller volumes and/or lower concentrations of sample or reagent material because of an increased likelihood that the sample or reagent will contact the respective areas of probe array 140 in a shorter time frame.

Turbulent fluid flow may be created by modulating the phase and/or amplitude of the input vibration to resonant elements 400. For example, the modulated input vibration is amplified by the sympathetic resonant characteristics of resonant elements 400. In the present example, the modulation of the vibrations creates an irregular mixing pattern producing turbulence in the fluid flow over probe array 140.

FIGS. 4A and 4B provide simplified graphical examples of resonant elements that may be used to stimulate the mixing of fluids. Resonant element 400 may include a structure that has a well defined mechanical resonant frequency that may sympathetically vibrate in response to an input of vibration. For example, element 400 may include a Reed-like type of structure or cantilever flexures constructed of silicon or other type of compatible material. Those of ordinary skill in the related art will appreciate that element 400 may include a variety of different structural shapes and/or sizes and may be constructed of a variety of materials where the combination of size, shape, and material composition of resonant element 400 possesses desirable resonant characteristics.

In some embodiments, a plurality of resonant elements 400 may be disposed in a patterned array within chamber 310 such that they are uniformly distributed with respect to what may be referred to as the active area of probe array 140. The term “active area” as used herein generally refers to the area of probe array 140 with probes disposed thereon. In alternative embodiments, a plurality of resonant elements 400 may be disposed upon a separate substrate or surface in a similar fashion such as, for instance, the distribution of resonant elements 400 on resonant element insert 405 of FIG. 4A. In some embodiments a plurality of elements 400 may be arranged where one or more of the elements may be tuned to a different resonant frequency resulting in variation of resonant characteristics among the plurality of elements. Also in some embodiments, the distribution of elements 400 on an area such as on insert 405 or the area of chamber 310 could include sub-dividing the area into a plurality of sub-areas where each sub-area comprises embodiments of resonant elements 400 that are responsive to a different frequency or range of frequencies than the other sub-areas. Also, sub-areas could be tuned to work in combination with one another with matching frequencies or overlapping ranges of frequencies, where one or more sub-areas could be sequentially and/or iteratively stimulated to promote turbulent flow of fluid within chamber 310. In the same or alternative embodiments the distribution of resonant elements 400 may be arranged in a variety of geometric patterns in each area or sub-area. In the illustrative example of FIG. 4A, insert 405 comprises an array or matrix of 8 resonant elements by eight resonant elements but those of ordinary skill in the art will appreciate that an array or other type geometric pattern of resonant elements may comprise a variety of different numbers and spatial distribution of elements, and that FIG. 4A is for illustrative purposes only and should not be limiting.

Resonant elements 400 may be inexpensively manufactured in chamber 310 or as part of resonant insert 405 using a variety of processes, such as micromachining methods known in the art that, for instance, include mechanical drilling/milling, Electro Discharge Machining, electroforming, laser micromachining, ultrasonic machining. Also resonant elements 400 may be constructed of a variety of materials such as silicon, aluminum, tungsten, stainless steel, thin plastics, or other suitable material. It may be advantageous in many applications that elements 400 be constructed out of a chemically inert or substantially chemical inert material to avoid undesirable reactions with fluids. For example, resonant elements insert 405 may be manufactured by processes known to those of ordinary skill in the related art as silicon micromachining that could include an array of elements 400 each manufactured to be 2 mm in length and 1 micron thick. In the present example, each of elements 400 may achieve, but are not limited to, resonant frequencies in the range of about 100-700 Hz and in particular about 350 Hz based, at least in part, upon the characteristics of each embodiment of element 400. Additionally, resonant frequencies could experimentally derived, and/or analytically worked out employing one or more parameters associated with vibration source 410, chamber 310, housing 300, including materials of manufacture, dimensions, range of possible frequencies, etc.

In some embodiments, insert 405 may be permanently placed in a fixed position within chamber 310 when constructed such as, for instance, by spotter/synthesizer 150. An alternative embodiment may include insert 405 that may be reversibly placed in and removed from chamber 310 by user 175 and/or one or more robotic instruments based, at least in part, upon the processing steps to be performed. Yet another embodiment may include probe array 140 being placed within a housing or cartridge with an implementation of insert 405 and/or elements 400 disposed within, where the housing or cartridge may be specifically constructed to be dedicated to one or more specific processing steps.

Sources of input vibration to each of elements 400 may include various types of vibration generating device known in the art such as, for example, one or more of a piezo-electric crystal, ultra sonic source, or other types of mechanical or acoustic vibration sources. Some embodiments may include a vibration source constructed into housing 300 such as vibration source 410 illustrated in FIG. 4B. Alternatively or in combination with source 410, a vibration source may be implemented in hybridization station 141, robotic or other types of processing instrument. For example, hybridization station 141 may position housing 300 such that it is in physical contact with one or more vibration sources where the vibration is transmitted through the material of housing 300 to resonant elements 400. Those of ordinary skill in the related art will appreciate that it may be advantageous in many applications that housing 300 be constructed of a material that has desirable vibration transmission properties such as a high level of transmission and low vibration dampening qualities. Alternatively housing 300 may include electrical contacts or other type of connection to interface with station 141 or other processing instrument, where the contacts may provide power and control of frequency and modulation of the vibration. In the same or alternative embodiments comprising contacts or connections associated with housing 300, one or more or all of resonant elements could be substituted with what are known in the art as Micro-Electrical-Mechanical-Mechanisms (sometimes referred to as MEMS) that may also be fabricated by micromachining processes and constructed of silicon or other compatible material. For example, the MEMS elements could comprise mechanical mixing elements such as, for instance, propellers, impellers, or other fluid pumping device that provide active mixing under the control of executables 299A that could be coordinated to provide turbulent flows over probe array 140 or particular sub-areas of probe array 140. Also, the MEMS elements may include sensor devices that could provide executables 299A with information related to flow rate, turbulence or other mechanical, thermal, biological, chemical, optical, and magnetic phenomena.

Embodiments of vibration source 410 or other vibration source may be under the control of executables 299A. For example, executables 299A may initiate a vibration phase using one or more vibration frequencies during one or more processing steps. In the embodiments of vibration source 410 being located external to housing 300, source 410 may be placed in physical contact with housing 300 where the vibrations may be transmitted through housing 300 and fluid, or more directly to a plurality of resonant elements 400 that vibrate sympathetically with the input vibration and act to amplify the input vibrations based, at least in part, upon the resonant design. Similarly, in embodiments of vibration source 410 being located internal to housing 300, the vibrations may be transmitted more directly to resonant elements 400 or resonant element insert 405. Executables 299A also provides control of the flow patterns within chamber 310 such as the chaotic or turbulent mixing created by modulation of the phase and/or amplitude of the vibrations.

In the same or alternative embodiments a plurality of implementations of vibration source 410 may be tuned to emit different frequencies of vibration or alternatively may be tuned to emit a broad band of frequency spectra and/or emit what those of ordinary skill in the related art refer to as “white noise”. For example, various implementations of element 400 may be selectively used by executables 299A during various processing steps by initiating vibrations of one or more specific frequencies.

Having described various embodiments and implementations, it should be apparent to those skilled in the relevant art that the foregoing is illustrative only and not limiting, having been presented by way of example only. Many other schemes for distributing functions among the various functional elements of the illustrated embodiment are possible. The functions of any element may be carried out in various ways in alternative embodiments. Also, the functions of several elements may, in alternative embodiments, be carried out by fewer, or a single, element. Similarly, in some embodiments, any functional element may perform fewer, or different, operations than those described with respect to the illustrated embodiment. Also, functional elements shown as distinct for purposes of illustration may be incorporated within other functional elements in a particular implementation.

Also, the sequencing of functions or portions of functions generally may be altered. Certain functional elements, files, data structures, and so on, may be described in the illustrated embodiments as located in system memory of a particular computer. In other embodiments, however, they may be located on, or distributed across, computer systems or other platforms that are co-located and/or remote from each other. For example, any one or more of data files or data structures described as co-located on and “local” to a server or other computer may be located in a computer system or systems remote from the server. Numerous other embodiments, and modifications thereof, are contemplated as falling within the scope of the present invention as defined by appended claims and equivalents thereto.

1. A method of mixing fluid comprising:
providing a vibration, wherein the vibration comprises a resonant frequency;
sympathetically amplifying the vibration in response to the resonant frequency; and
modulating the resonant frequency, wherein the modulated resonant frequency causes the amplified vibration to generate turbulent flow in a fluid that influences the likelihood of interaction between a target molecule in the fluid with a probe on a biological probe array.

2. The method of claim 1, wherein:
the vibration is provided by a piezo-electric crystal.

3. The method of claim 1, wherein:
the vibration is provided by an ultrasonic source.

4. The method of claim 1, wherein:
the resonant frequency comprises a range of frequencies.

5. The method of claim 1, wherein:
the vibration is sympathetically amplified via a plurality of resonant elements, wherein each resonant element is responsive to the resonant frequency.

6. The method of claim 5, wherein:
the plurality of resonant elements are arranged on a first surface opposite a second surface, wherein the second surface comprises the biological probe array.

7. The method of claim 5, wherein:
the plurality of resonant elements are arranged in a chamber.

8. The method of claim 7, wherein:
the chamber comprises boundaries defined by a housing.

9. The method of claim 5, wherein:
the plurality of resonant elements are arranged on an insert, wherein the insert is positioned in a housing.

10. The method of claim 9, wherein:
the insert defines a first surface opposite a second surface, wherein the second surface comprises the biological probe array.

11. The method of claim 1, wherein:
the modulating step comprises phase-modulation of the resonant frequency.

12. The method of claim 1, wherein:
the modulating step comprises amplitude modulation of the resonant frequency.

13. The method of claim 1, wherein:
the modulating step generates an irregular mixing pattern.

14. The method of claim 1, wherein:
the turbulent flow disrupts a boundary layer.

15. The method of claim 14, wherein:
the boundary layer comprises a layer of the fluid where the velocity of the fluid is zero at an interface of the fluid with a surface.

16. The method of claim 15, wherein:
the surface comprises the biological probe array.

17. The method of claim 1, wherein:
the influenced likelihood of interaction provides for an increase in a rate of interaction.

18. The method of claim 1, wherein:
the influenced likelihood of interaction provides for an improvement of efficiency.

19. A system for mixing fluid comprising:
a vibration source that provides a vibration comprising a resonant frequency;
a plurality of resonant elements that sympathetically amplify the vibration in response to the resonant frequency; and
an instrument control application that modulates the resonant frequency, wherein the modulated resonant frequency causes the amplified vibration to generate turbulent flow in a fluid that influences the likelihood of interaction between a target molecule in the fluid with a probe on a biological probe array.

20. The system of claim 19, wherein:
the vibration is provided by a piezo-electric crystal.

21. The system of claim 19, wherein:
the vibration is provided by an ultrasonic source.

22. The system of claim 19, wherein:
the resonant frequency comprises a range of frequencies.

23. The system of claim 19, wherein:
the vibration is amplified via a plurality of resonant elements, wherein each resonant element is responsive to the resonant frequency.

24. The system of claim 23, wherein:
the plurality of resonant elements are arranged on a first surface opposite a second surface, wherein the second surface comprises the biological probe array.

25. The system of claim 23, wherein:
the plurality of resonant elements are arranged in a chamber.

26. The system of claim 25, wherein:
the chamber comprises boundaries defined by a housing.

27. The system of claim 23, wherein:
the plurality of resonant elements are arranged on an insert, wherein the insert is positioned in a housing.

28. The system of claim 27, wherein:
the insert defines a first surface opposite a second surface, wherein the second surface comprises the biological probe array.

29. The system of claim 19, wherein:
the modulation comprises phase-modulation of the resonant frequency.

30. The system of claim 19, wherein:
the modulation comprises amplitude modulation of the resonant frequency.

31. The system of claim 19, wherein:
the modulation generates an irregular mixing pattern.

32. The system of claim 19, wherein:
the turbulent flow disrupts a boundary layer.

33. The system of claim 32, wherein:
the boundary layer comprises a layer of the fluid where the velocity of the fluid is zero at an interface of the fluid with a surface.

34. The system of claim 33, wherein:
the surface comprises the biological probe array.

35. The system of claim 19, wherein:
the influenced likelihood of interaction provides for an increase in a rate of interaction.

36. The system of claim 19, wherein:
the influenced likelihood of interaction provides for an improvement of efficiency.

37. A system for mixing fluid, comprising:
a probe array that selectively hybridizes a plurality of target molecules to a plurality of associated probes disposed upon the probe array, wherein the plurality of target molecules are in a fluid;
a plurality of resonant elements positioned on a surface opposite the probe array, wherein each resonant element is responsive to a resonant frequency; and
a vibration source that provides a first vibration comprising the resonant frequency, wherein the resonant elements vibrate sympathetically in response to the first vibration producing a second vibration comprising the resonant frequency that is amplified over the first vibration, and further wherein the second vibration causes mixing of the fluid.

38. The system of claim 37, wherein:
the resonant elements comprise cantilever structures.

39. The system of claim 38, wherein:
the mixing of the fluid is caused by turbulence in the fluid.

40. The system of claim 38, wherein:
the mixing of the fluid is caused by momentum changes in the fluid.

41. A system for mixing fluid comprising:
a processing instrument that accepts one or more housings each comprising a biological probe array and a plurality of resonant elements; and
a computer comprising executable code stored in a system memory, wherein the executable code performs the method of:
instructing the processing instrument to provide a vibration comprising a resonant frequency, wherein the plurality of resonant elements sympathetically amplify the vibration in response to the resonant frequency; and
instructing the processing instrument to modulate the resonant frequency, wherein the modulated resonant frequency causes the amplified vibration to generate turbulent flow in a fluid that influences the likelihood of interaction between a target molecule in the fluid with a probe on the biological probe array.
